(19) United States
(12) Patent Application Publication
(10) Pub. No.: US 2006/0227943 A1
(43) Pub. Date: Oct. 12, 2006

(54) Rule-based instant message retention

(75) Inventor: Shunguo Yan, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/103,693

(22) Filed: Apr. 12, 2005

(51) Int. Cl. H04M 1/64

(52) U.S. Cl. 379/67.1; 379/88.22; 379/88.25; 379/88.23

(57) ABSTRACT

A method in a data processing system for rule-based instant message retention. The method records a start time and creates storage to hold a set of messages when an IM session starts. Then the method determines if the set of messages needs to be retained by applying a set of user-defined rules to the set of messages when the IM session is terminated. If the set of messages needs to be retained, the method indexes the set of messages using a set of metadata. Next, the method compresses, encrypts, and password protects the set of messages. After that, the method protects the set of messages from overwriting and retains the set of messages in storage. Later, the method establishes which sets of retained messages no longer need to be retained. If a set of retained messages no longer needs to be retained, the method discards the set of retained messages.

### BACKGROUND OF THE INVENTION

1. Technical Field

The present invention relates generally to an improved data processing system and, in particular, to a method, system and computer program product for optimizing performance in a data processing system. Still more particularly, the present invention provides a method, system, and computer program product for enhancing performance through rule-based retention of instant messages.

2. Description of Related Art

Instant Messaging (IM) is a type of communications service that enables a computer user to create a kind of private chat room with another individual in order to communicate in real time over the Internet, similar to a telephone conversation, but using text-based communication instead of voice-based communication. Typically, the instant messaging system alerts the user whenever somebody on the user's private list is online. The user can then initiate a chat session with that particular individual.

Instant messaging provides a convenient real-time and low cost communication channel among coworkers, customers, and suppliers. IM can save time and money on long-distance phone bills. IM replaces telephone calls more often than it does e-mail, as it augments e-mail, but does not supplant e-mail. However, instant messages are harder to monitor, track, and retain than e-mails. IM is more like talking than writing, so it is rarely retained, unless one party has a specific reason to save it. But the manner in which IM is currently saved makes it dangerous, because it can only be saved in plain text that can easily be altered. How each company deals with saving IM differs, based on its workplace culture and technological capabilities.

As IM grows, there is a need to retain it for possible future litigation. The Security and Exchange Commission's record retention rule requires saving electronic documents for a certain number of years in case the records are needed for investigation. According to emerging legal interpretations of the rule, as a practical matter every public company—and possibly some private ones—has to keep electronic document records, which include instant messages.

Unlike an e-mail which is sent as one message and can be kept either in a mail server or in a mail client, instant messages span a time period and are gone when the messaging session is terminated, unless the instant message is explicitly saved. Although most IM engines (AOL, AIM, MSN Messenger, Yahoo Messenger, etc.) provide a way for the participants to save or log instant messages, the messages can only be saved as a plain text file in the client side, which can easily be altered. Considering the time span during messaging and the potential number of messages, saving messages can be time, storage, and bandwidth consuming. Therefore, it would be advantageous to have an improved method, system, and computer program product to save instant messages.

### SUMMARY OF THE INVENTION

The present invention is a method, system, and computer program product in a data processing system for rule-based instant message retention. The event-based program records a start time and creates storage to hold a set of messages when an IM session starts. Then the event-based program determines if the set of messages needs to be retained by applying a set of user-defined rules to the set of messages when the IM session is terminated. If the set of messages needs to be retained, the index service indexes the set of messages using a set of metadata. Next, the compress service compresses, the encrypt service encrypts, and the password protect service password protects the set of messages. After that, the overwrite protect service protects the set of messages from overwriting and the retain service retains the set of messages in storage. Later, the scan service establishes which sets of retained messages no longer need to be retained. If a set of retained messages no longer needs to be retained, the discard service discards the set of retained messages.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram illustrating components used in managing messages in accordance with a preferred embodiment of the present invention;

FIG. 4 is a block diagram illustrating services used and a program that invokes the services for rule-based retention of instant messages in accordance with a preferred embodiment of the present invention;

FIG. 5 is a block diagram of the rules for rule-based retention of instant messages in accordance with a preferred embodiment of the present invention; and

FIG. 6 is a flowchart of the process for rule-based retention of instant messages in accordance with a preferred embodiment of the present invention.

### DETAILED DESCRIPTION OF THE PREFERRED EMBODIMENT

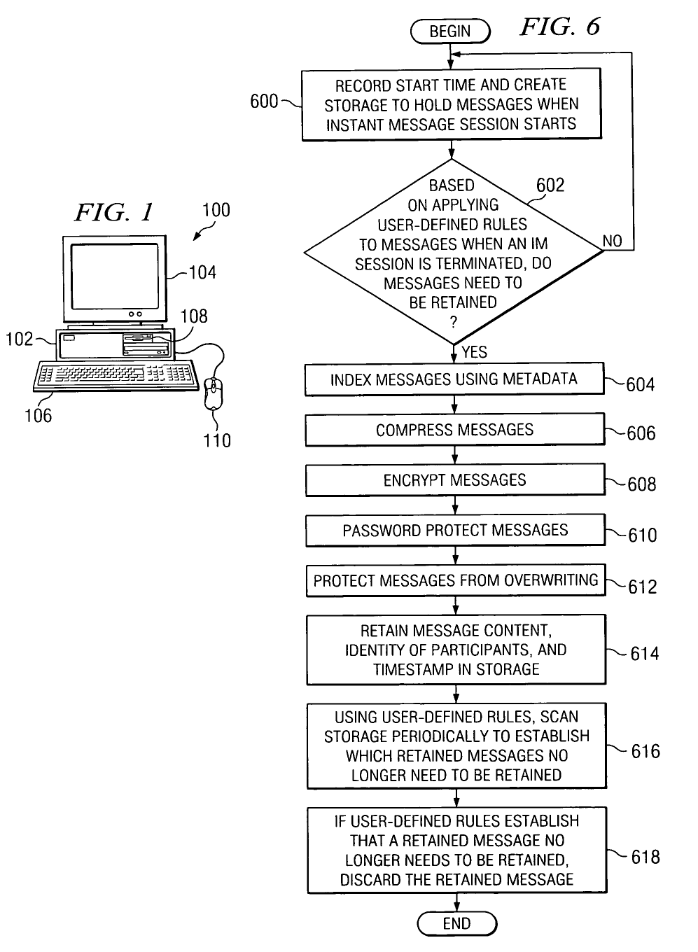

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

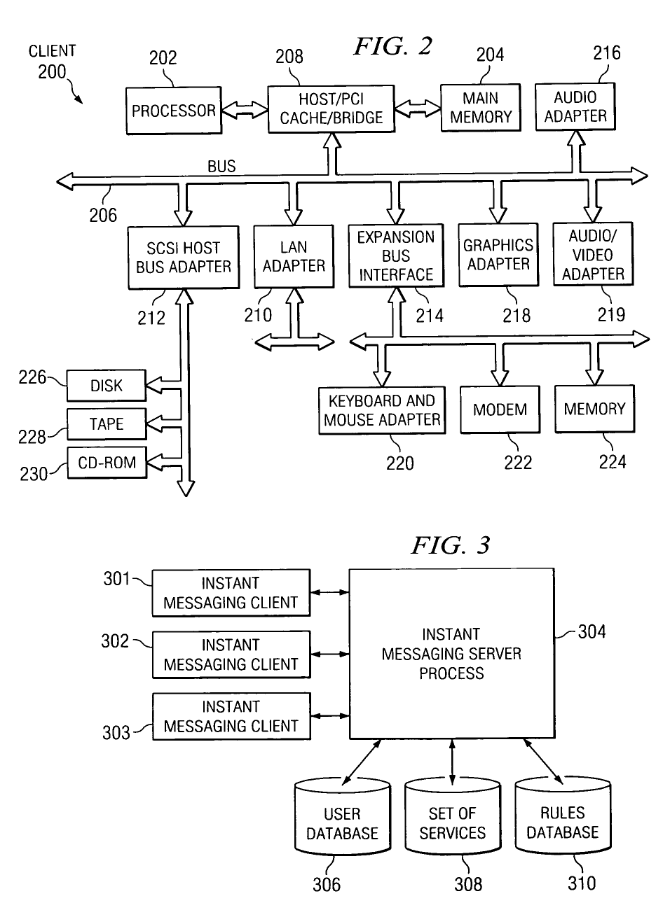

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Turning now to FIG. 3, a block diagram illustrating components used in an instant messaging system in accordance with a preferred embodiment of the present invention is shown. In this illustrative example, a user at instant messaging client 301 may send or exchange messages with other users at instant messaging clients 302 and 303. These instant messaging clients may be executing on a data processing system, such as data processing system 200 in FIG. 2. The exchange of messages in these examples is facilitated through instant messaging server process 304. This process allows for users to find other users within the instant messaging system as well as aid in the exchange of messages between different users.

Depending on the particular instant messaging system, instant messaging server process 304 may only be involved in providing an indication of when particular users are online and for establishing initial contacts while users contacting users already on a buddy list may contact those users directly after seeing that a particular user is online. Instant messaging server process 304 may be located on a server, such as data processing system 200 in FIG. 2.

In these examples, the different users registered to the instant messaging system are stored in user database 306. This user database provides information needed to search for and find other users as well as contact users when they are online. The different services programmed by the user are stored in set of services 308. The different rules programmed by the user are stored in rules database 310.

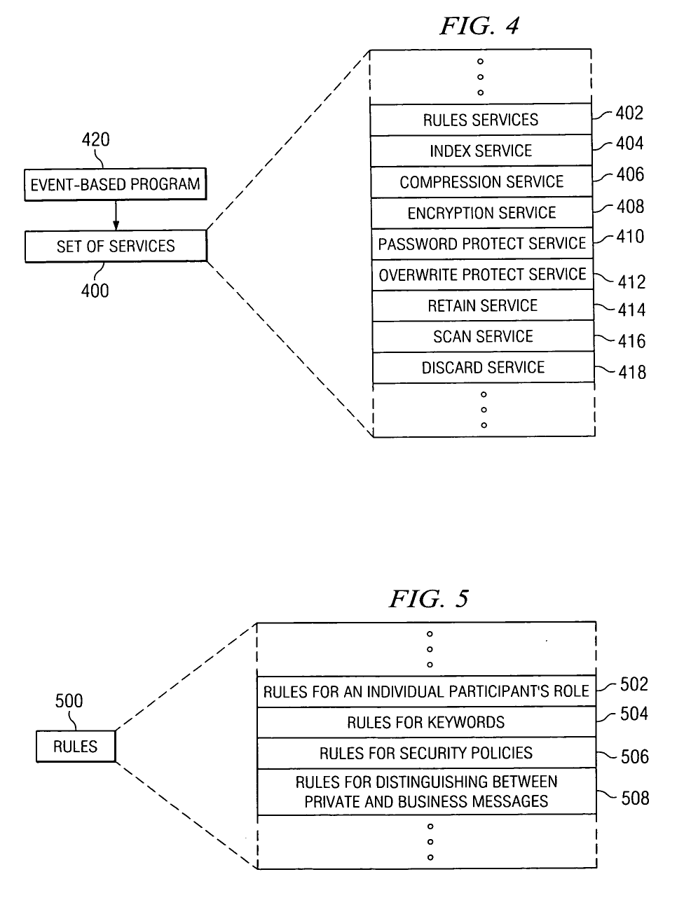

FIG. 4 is a block diagram of the set of services and the program that invokes the services for rule-based retention of instant messages in accordance with a preferred embodiment of the present invention. Set of services 400 comprises services (subroutines or engines) that are programmed by the user, based on the user's needs. For instance, the user programs rule service 402 for the pre-compiled business rules and programs the priorities for index service 404 which is used for the pre-compiled index mechanism. The present invention can also offer compression service 406 for compressing the given text and encryption service 408 for encrypting the given text. Event-based program 420 can monitor the messaging process and apply set of services 400. Event-based program 420 can monitor a series of events (such as a session start, a session end, an individual joining or leaving, etc.) and handle the events correspondingly. For example, once event-based program 420 has applied rules service 402 and determined that the messages need to be saved, event-based program 420 invokes index service 404, compression service 406 and encryption service 408 to index, compress and encrypt the messages, respectively. After that, event-based program 420 can invoke password protect service 410 and overwrite protect service 412, to password protect the encrypted messages and to protect messages from overwriting, respectively. Finally, event-based program 420 can invoke retain service 414 to retain the message content, together with the identity of all the participants, and timestamps (start and end) in a permanent storage for future use. The messages are retained in a server, such as data processing system 200 in FIG. 2, to insure better protection and to facilitate fast searches and access.

In another example, later in time event-based program 420 in FIG. 4 applies the rules to determine when to invoke scan service 416. Scan service 416 scans the storage periodically to establish which retained messages no longer need to be retained. If the rules establish that a retained message no longer needs to be retained, scanning service 416 invokes discard service 418 to discard the retained message.

FIG. 5 is a block diagram of the rules for rule-based retention of instant messages in accordance with a preferred embodiment of the present invention. The present invention may be implemented as an improved method to retain instant messages using components of a data processing system, such as data processing system 200 in FIG. 2. The rules 500, as shown in FIG. 5, for IM retention purposes may be defined by the invention's user based upon the user's company policies, wherein the set of rules that comprise the rules contains one or more rules. The rules 500 specify what instant messages (as well as the file or URL attachments) should be retained or destroyed, wherein the set of instant messages that comprise the instant messages contains one or more instant messages. For example, the rules can be based on an individual participant's role 502, the responsibility to keep only the messages sent by a certain group of individuals, such as executives or managers. The set of rules based on an individual participant's role that comprises the rules based on an individual participant's role 502 contains one or more rules based on an individual participant's role. The rules may also be created by the user based on keywords 504 related to the user's business processes, technologies, product names or brands, whereby the messages which contain the specific words are kept. The set of rules based on keywords that comprises the rules based on keywords 504 contains one or more rules based on keywords. The indexing is based on metadata, which is based on the rules, such as the rules for an individual participant's roles 502 and the rules for keywords 504, wherein the set of metadata that comprises the metadata contains one or more metadata. Furthermore, the rules may specify security policies 506 as to who can access the messages after being retained. The set of rules specifying security policies that comprises the rules specifying security policies 506 contains one or more rules specifying security policies. In addition, the rules may specify policies to distinguish between private and business messages 508.

FIG. 6 is a flowchart of the process for rule-based retention of instant messages in accordance with a preferred embodiment of the present invention. The present invention may be implemented as an improved method to retain instant messages using components of a data processing system, such as data processing system 200 in FIG. 2. When an IM session is established, the IM server creates a temporary storage in memory to hold each individual message with the identity of the individual who wrote the message, along with any file or URL attachment, until the session is terminated. When an IM session starts, the event-based program, such as event-based program 410 in FIG. 4, records the start time and creates a temporary storage in memory to hold the messages (step 600), in a manner similar to the IM server. When the IM session is terminated, the event-based program automatically applies the user-defined rules, such as rules 500 in FIG. 5, to the messages to determine whether the messages need to be retained or not (step 602).

If the messages need to be retained, they are indexed by an index service (step 604), such as index service 404 in FIG. 4, using metadata (participants, keywords) with the indexing classification based on the user-defined rules in order to promote fast search and retrieval. Then, in order to save storage space, the messages are compressed (step 606) by a compression service, such as compression service 406 in FIG. 4. Next, the messages are encrypted (step 608) by an encryption service, such as encryption service 408 in FIG. 4. After that, the encrypted messages are password protected (step 610) by a password protect service, such as password protect service 410 in FIG. 4. With audits or litigation in mind, the messages are protected from overwriting (step 612) by an overwrite protect service, such as overwrite protect service 412 in FIG. 4. Finally, the message content, together with the identity of all the participants, and timestamps (start and end) are retained into a permanent storage for future use (step 614) by a retain service, such as retain service 414 in FIG. 4.

Based on the rules, the storage is scanned periodically to establish which retained messages no longer need to be retained (step 616) by a scan service, such as scan service 416 in FIG. 4. If the rules establish that a retained message no longer needs to be retained, the retained message is discarded (step 618) by a discard service, such as discard service 418 in FIG. 4. Altogether, the process as shown in FIG. 6 provides an improved method to retain instant messages based on user-defined rules.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for retaining instant messages, the method comprising:
recording a start time and creating a storage to hold a set of messages when an instant messaging session starts;
determining if the set of messages needs to be retained by applying a set of rules to the set of messages when the instant messaging session is terminated;
responsive to determining that the set of messages needs to be retained, indexing the set of messages using a set of metadata; and
retaining the set of messages in a other storage.

2. The method of claim 1 further comprising:
responsive to indexing the set of messages using the set of metadata, compressing the set of messages;
encrypting the set of messages;
password protecting the set of messages; and
protecting the set of messages from overwriting.

3. The method of claim 1 further comprising:
responsive to retaining the set of messages in the other storage, establishing which sets of retained messages no longer need to be retained; and
responsive to establishing that a set of retained messages no longer needs to be retained, discarding the set of retained messages.

4. The method of claim 1 wherein the set of rules includes rules for a set of individual participants.

5. The method of claim 1 wherein the set of rules includes rules for a set of keywords.

6. The method of claim 1 wherein the set of rules includes rules for a set of security policies.

7. The method of claim 1 wherein the set of rules includes rules for distinguishing between a private message and a business message.

8. The method of claim 1 wherein the set of messages includes a content, a set of participant identities, and a timestamp.

9. A data processing system for retaining instant messages, the data processing system comprising:
recording means for recording a start time and creating a storage to hold a set of messages when an instant messaging session starts;
determining means for determining if the set of messages needs to be retained by applying a set of rules to the set of messages when the instant messaging session is terminated;
responsive to determining that the set of messages needs to be retained, indexing means for indexing the set of messages using a set of metadata; and
retaining means for retaining the set of messages in a other storage;

10. The data processing system of claim 9 further comprising:
responsive to indexing the set of messages using the set of metadata, compressing means for compressing the set of messages;
encrypting means for encrypting the set of messages;
password protecting means for password protecting the set of messages; and
protecting means for protecting the set of messages from overwriting.

11. The data processing system of claim 9 further comprising:
responsive to retaining the set of messages in the other storage, establishing means for establishing which sets of retained messages no longer need to be retained; and
responsive to establishing that a set of retained messages no longer needs to be retained, discarding means for discarding the set of retained messages.

12. The data processing system of claim 9 wherein the set of rules includes rules for a set of individual participants.

13. The data processing system of claim 9 wherein the set of rules includes rules for a set of keywords.

14. The data processing system of claim 9 wherein the set of rules includes rules for a set of security policies.

15. The data processing system of claim 9 wherein the set of rules includes rules for distinguishing between a private message and a business message.

16. The data processing system of claim 9 wherein the set of messages includes a content, a set of participant identities, and a timestamp.

17. A computer program product on a computer-readable medium for retaining instant messages, the computer program product comprising:
first instructions for recording a start time and creating a storage to hold a set of messages when an instant messaging session starts;
second instructions for determining if the set of messages needs to be retained by applying a set of rules to the set of messages when the instant messaging session is terminated;
responsive to determining that the set of messages needs to be retained, third instructions for indexing the set of messages using a set of metadata; and
fourth instructions for retaining the set of messages in a other storage.

18. The computer program product of claim 17 wherein the set of rules includes rules for a set of individual participants.

19. The computer program product of claim 17 wherein the set of rules includes rules for a set of keywords.

20. The computer program product of claim 17 wherein the set of rules includes rules for a set of security policies.
